(19) United States
(12) Patent Application Publication
(10) Pub. No.: US 2012/0251016 A1
(43) Pub. Date: Oct. 4, 2012

(54) TECHNIQUES FOR STYLE TRANSFORMATION

(76) Inventors: Kenton Lyons, San Jose, CA (US); Barbara Rosario, Berkeley, CA (US); Trevor Pering, San Francisco, CA (US); Roy Want, Los Altos, CA (US)

(21) Appl. No.: 13/078,651

(22) Filed: Apr. 1, 2011

(51) Int. Cl. G06K 9/36

(52) U.S. Cl. 382/276

(57) ABSTRACT

Techniques to stylistically transform source text are disclosed. A source text and information about an output channel may be received. The source text may be stylistically transformed based on the information about the output channel. The stylistically transformed source text may be output. Other embodiments are described and claimed.

### BACKGROUND

Textual content may be presented to users by a variety of technologies. Content is often presented in a way that is different than what was originally expected by the writer of the content. For example, a user may wish to listen to a news article that was originally intended to be read on a desktop or laptop computer monitor. As the news article was intended to be read by a user, there may be stylistic challenges in orally listening to the article. For example, a sentence may be too long to easily follow when listening. Alternatively, a short and contextually important word such as “not” may be missed when hearing content.

Alternatively, a user may wish to read a news article on their cell phone that was originally intended to be read on a desktop or laptop computer. Visual challenges may include lengthy paragraphs or inappropriate page breaks. As the text is being viewed in a way that is different from the original expectation, readability may be decreased which may result in a decrease in a user's comprehension.

Currently, transformation between text formats for different technologies are typically performed manually. Automatic transformations only summarize or reflow a document and do not take into account necessary stylistic changes based on the type of technology used. Consequently, there exists a substantial need for textual content to be transformed based on the technology chosen.

### BRIEF DESCRIPTION OF THE DRAWINGS

FIG. 1 illustrates an embodiment of a block diagram for a system.

FIG. 2 illustrates an embodiment of the style transformation system.

FIGS. 3A and 3B illustrate embodiments of a model component.

FIG. 4 illustrates an embodiment of an output occurrence component.

FIG. 5 illustrates an embodiment of the style optimization component.

FIG. 6 illustrates an embodiment of a logic flow.

FIG. 7 illustrates an embodiment of an exemplary computing architecture.

### DETAILED DESCRIPTION

Embodiments are generally directed to techniques designed to stylistically transform text. Various embodiments provide techniques that include a style transformation technique which receives a text and information about an output channel. The source text may be stylistically transformed based on the information about the output channel. In an embodiment, one or more transformation rules may be determined based on the information about the output channel and the transformation rules may be applied to stylistically transform the source text. The stylistically transformed source text may be output. Other embodiments are described and claimed.

Embodiments may include one or more elements. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

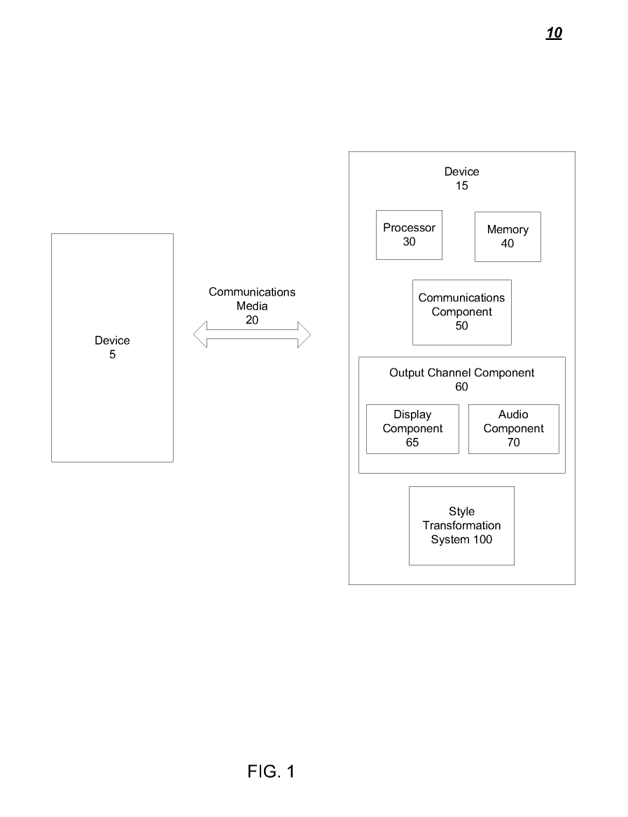

FIG. 1 illustrates an embodiment of a block diagram for a system 10. In one embodiment, the system 100 may comprise a communications system 10. Although the system 100 shown in FIG. 1 has a limited number of elements in a certain topology, it may be appreciated that the system 10 may include more or less elements in alternate topologies as desired for a given implementation.

In various embodiments, the communications system 10 may comprise, or form part of a wired communications system, a wireless communications system, or a combination of both. For example, the communications system 10 may include one or more devices arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more devices arranged to communicate information over one or more types of wireless communication links, such as wireless shared media 50. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands. In the latter case, the wireless devices may include one or more wireless interfaces and/or components for wireless communication, such as one or more transmitters, receivers, transmitter/receivers (“transceivers”), radios, chipsets, amplifiers, filters, control logic, network interface cards (NICs), antennas, antenna arrays, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth. In one embodiment, certain devices may include antenna arrays of multiple antennas to implement various adaptive antenna techniques and spatial diversity techniques.

The communications system 10 may communicate information in accordance with one or more standards as promulgated by a standards organization. In various embodiments, the communications system 10 may comprise or be implemented as a mobile broadband communications system. Examples of mobile broadband communications systems include, without limitation, systems compliant with various Institute of Electrical and Electronics Engineers (IEEE) standards, such as the IEEE 802.11 standards for Wireless Local Area Networks (WLANs) and variants, the IEEE 802.16 standards for Wireless Metropolitan Area Networks (WMANs) and variants, and the IEEE 802.20 or Mobile Broadband Wireless Access (MBWA) standards and variants, among others. In one embodiment, for example, the communications system 100 may be implemented in accordance with the Worldwide Interoperability for Microwave Access (WiMAX) or WiMAX II standard. WiMAX is a wireless broadband technology based on the IEEE 802.16 standard of which IEEE 802.16-2004 and the 802.16e amendment (802.16e-2005) are Physical (PHY) layer specifications. WiMAX II is an advanced Fourth Generation (4G) system based on the IEEE 802.16j and IEEE 802.16m proposed standards for International Mobile Telecommunications (IMT) Advanced 4G series of standards. The embodiments are not limited in this context.

The communications system 10 may communicate, manage, or process information in accordance with one or more protocols. A protocol may comprise a set of predefined rules or instructions for managing communication among devices. In various embodiments, for example, the communications system 10 may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

The communication system 10 may have one or more devices 5, 15. A device 5, 15 generally may comprise any physical or logical entity for communicating information in communications system 10. A device 5, 15 may be implemented as hardware, software, or any combination thereof, as desired for a given set of design parameters or performance constraints. Although FIG. 1 may show a limited number of devices by way of example, it can be appreciated that more or less devices may be employed for a given implementation.

In an embodiment, a device 5, 15 may be a computer-implemented system having one or more software applications and/or components. For example, a device 5, 15 may comprise, or be implemented as, a computer system, a computing device, a computer sub-system, a computer, an appliance, a workstation, a terminal, a server, a personal computer (PC), a laptop, an ultra-laptop, a handheld computer, a personal digital assistant (PDA), a smart phone, a tablet computer, a gaming device, a set top box (STB), a television, a digital television, a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In an embodiment, a device 5, 15 may comprise, or be implemented as, software, a software module, an application, a program, a subroutine, an instruction set, computing code, words, values, symbols or combination thereof. A device 5, 15 may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

A device 5 may communicate with other devices, such as, but not limited to, device 15, over a communications media 20 using communications signals via the communications component 50. By way of example, and not limitation, communications media 20 includes wired communications media and wireless communications media. Examples of wired communications media 50 may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The devices 5, 15 of communications system 10 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a device to process the media information in a certain manner. The media and control information may be communicated from and to a number of different devices or networks.

As shown in FIG. 1, device 15 may include multiple elements, such as a processor 30, a memory 40, a communications component 50, a display component 60, an audio component 70 and a style transformation system 100. The embodiments, however, are not limited to the elements or the configuration shown in this figure.

In various embodiments, a device 15 may include a processor 30. The processor 30 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processor 30 may be implemented as a general purpose processor, such as a processor made by Intel® Corporation, Santa Clara, Calif. The processor 30 may also be implemented as a dedicated processor, such as a controller, microcontroller, embedded processor, a digital signal processor (DSP), a network processor, a media processor, an input/output (I/O) processor, and so forth. The processor 30 may have any number of processor cores, including one, two, four, eight or any other suitable number. The embodiments are not limited in this context.

A processor 30 may include any type of processing unit, such as, but not limited to, a computer processing unit (CPU), a multi-processing unit, a digital signal processor (DSP), a graphical processing unit (GPU) and an image signal processor. Alternatively, the multi-core processor may include a graphics accelerator or an integrated graphics processing portion. The present embodiments are not restricted by the architecture of the processor 30, so long as the processor 30 supports the modules and operations as described herein. The processor 30 may execute the various logical instructions according to the present embodiments.

In various embodiments, memory 40 may include various types of computer-readable storage media in the form of one or more higher speed memory units. The memory 40 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

The device 15 may execute communications operations or logic using communications component 50. The communications component 50 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 50 may include various types of standard communication elements, such as one or more communications interfaces, network interfaces, network interface cards (NIC), radios, wireless transmitters/receivers (transceivers), wired and/or wireless communication media, physical connectors, and so forth.

The communications components 50 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context. When communications component 140 is implemented as software, the software may be executed by any suitable processor and memory unit.

The device 15 may include an output channel component 60. The output channel component 60 may provide source text to a user. For example, the output channel component 60 may be a display component 65 on which a user may read source text. Additionally or alternatively, the output channel component 60 may be an audio component 70 by which a user may hear source text which was converted into speech.

The output channel component 60 may include a display component 65. Display component 65 may comprise any suitable display unit for displaying information on a device. In addition, display component 65 may be implemented as an additional I/O device, such as a touch screen, touch panel, touch screen panel, and so forth. Touch screens may comprise display overlays which are implemented using one of several different techniques, such as pressure-sensitive (resistive) techniques, electrically-sensitive (capacitive) techniques, acoustically-sensitive (surface acoustic wave) techniques, photo-sensitive (infra-red) techniques, and so forth. The effect of such overlays may allow a display to be used as an input device, removing or enhancing the keyboard and/or the mouse as the primary input device for interacting with content provided on a display component 65. In one embodiment, for example, display component 65 may be implemented by a liquid crystal display (LCD), plasma, projection screen or other type of suitable visual interface.

In various embodiments, the display component 65 may be a screen of varying sizes. In an embodiment, the display component 65 may be a large screen such as a 21″ screen on a device such as, but not limited to, a laptop. In an embodiment, the display component 65 may be a small screen such as 2″ screen on a handheld device such as, but not limited to, a mobile phone. In an embodiment, the display component 65 may be a display such as, but not limited to, an electronic marquee. The types of displays are not limited by the embodiments described.

The output channel component 60 may include an audio component 70. An audio component 70 may include one or more speakers. The audio component 70 may output speech. In an embodiment, the audio component 70 may include a component to convert source text into speech.

The device may include a style transformation system 100. The style transformation system 100 may transform source text based on the way the transformed source text will be output. For example, the source text may be displayed on a smaller screen, a projection screen, and/or converted to speech.

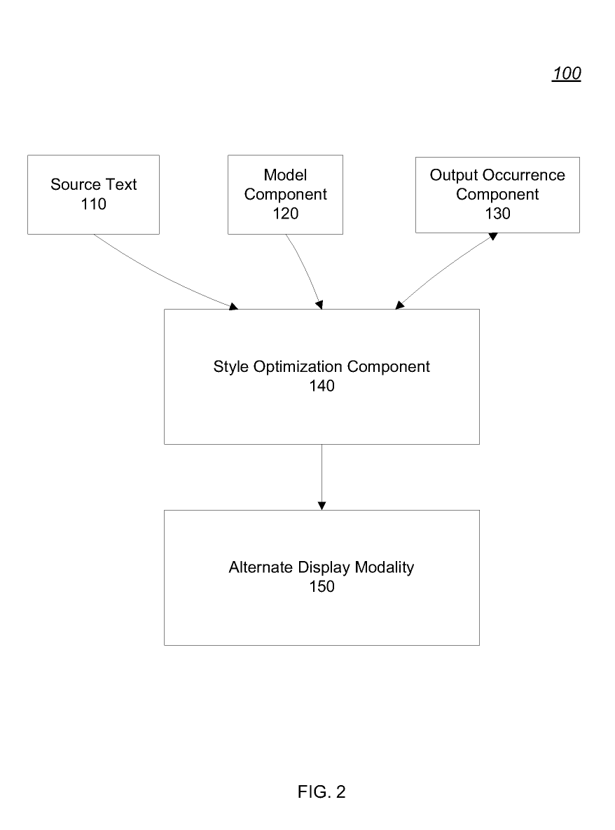

FIG. 2 illustrates an embodiment of the style transformation system 100. The style transformation system 100 may include at least a source text 110, a model component 120, an output occurrence component 130 and a style optimization component 140. In various embodiments, source text 110, one or more models from the model component 120 and one or more output channel types from the output occurrence component 130 may be received by the style optimization component 140.

In FIG. 2, source text 110 may be text or other semantically based information received by the style optimization component 140. The source text 110 may include written language. For example, source text 110 may be a writing including a plurality of glyphs, characters, symbols and/or sentences. The source text 110 may include a magazine article, a newspaper article, a paper, a book or some other set of writings, an e-mail, text on a webpage, a text message or other written message transmitted between mobile devices, or any other written form. In various embodiments, the source text 110 is the written language that may be transformed by the styrele optimization component 140.

In an embodiment, the source text 110 may be the spoken word as the source text does not have to originate as written text. The source text 110 may have originally been speech that was converted to text via a speech recognition system. For example, source text 110 may include voicemail or other spoken information converted into source text.

In an embodiment, the source text 110 may be a combination of texts. For example, the source text 110 may include combinations of one or more e-mails, books, articles, webpages and/or blogs. For example, a source text 110 may include text from both an instruction manual and a how-to book.

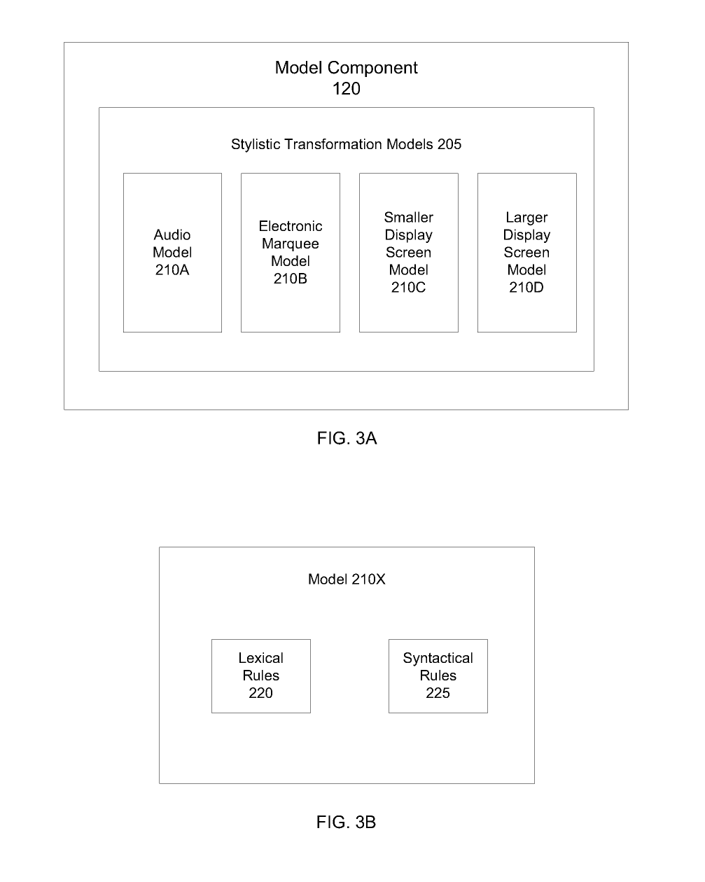

A model component 120 may include one or more models. Each model may include one or more rules based on the intended output channel of the source text. FIGS. 3A and 3B illustrate embodiments of a model component. As shown in FIG. 3B, a model component 120 may include learned stylistic transformation models 205. In an embodiment, each output channel may have a separate model 210A-X. The output channel may be the type of display by which the transformed source text is transmitted to a user. For example, the output channel may be, but is not limited to, a computer display screen, a projection screen, a set of speakers and/or an electronic bulletin board. In various embodiments, there may be a separate model 210A-X for each output channel. For example, there may be an audio model 210A, an electronic marquee model 210B, a smaller display screen model 210C and/or a larger display screen model 210D. The output channel models 210X are not limited to these embodiments.

In an embodiment, the output channel models 210X listed may be further divided into smaller sets. For example, an electronic marquee model 210B of one size may have different rules than an electronic marquee model 210B of a different size.

Each output channel model 210 may have one or more rules. As discussed above, there may be different rules based on the type of model. For example, there may be different rules for converting the source text to audio model 210A than for converting the source text to an electronic marquee model 210B.

In an embodiment, rules may overlap between models 210X. For example, both the electronic marquee model 210B and the smaller display screen model 210C may have rules related to the length of a sentence.

As shown in FIG. 3B, the output channel models 210X may have different types or categories of rules. In an embodiment, a user may create the rules. In an embodiment, the rules may be automatically learnt by the system. In an embodiment, the rules may be created via a combination of hand-crafted rules by a user and automatically learnt rules by the system.

In an embodiment, the output channel models 210X may have lexical rules 220. Lexical rules 220 may be word-based rules. In an embodiment, lexical rules 220 may be based on the style of the output channel. For example, a lexical rule 220 may cover word choice. Lexical rules 220 may be, but are not limited to, rules regarding sentence length, number of syllables per word and/or paragraph length. For example, a lexical rule 220 may state that an adjective or adverb should be removed if the number of adjectives and/or adverbs in a page, a paragraph, a phrase and/or a sentence of a source text exceeds a maximum number.

Additionally or alternatively, a lexical rule 220 may state that a word must be shortened or replaced if the number of letters in the word exceeds a maximum number. Additionally or alternatively, a lexical rule 220 may state that the number should be approximated so that 1,153 may be output via the output channel as eleven hundred.

Additionally or alternatively, a lexical rule 220 may state that a word exceeds a maximum number of syllables should be replaced with a synonym. Additionally or alternatively, a lexical rule 220 may state that certain words are too formal and should be replaced with more common usage words and/or phrases.

Lexical rules 220 may vary based on the type of output channel. For example, the source text may be a novel to be output via an audio output channel and a lexical rule 220 may remove descriptive language in order to shorten the source text. Additionally or alternatively, a longer sentence length may not be an issue for a larger display screen output channel, but may impede a user's understanding on a smaller screen display screen output channel. In an embodiment, a lexical rule 220 may state that a paragraph must be shortened if the sentences exceed a maximum number or if the number of words in the paragraph exceeds a maximum number. A lexical rule 220 related to the paragraph length may ensure that the paragraph is easily understandable to a reader on a smaller display screen output. In another example, a lexical rule 220 may state that the paragraph should be summed up into a single sentence of no more than a maximum number of words if the source text is displayed on an electronic marquee output channel. Accordingly, a larger display screen model 210D may not include a lexical rule 220 about sentence length, but a smaller display screen model 210C may include a lexical rule 220 about the length of a sentence. In an embodiment, a lexical rule 220 may state that a sentence length must be shorter than a threshold so that the sentence may be easily understood by a user listening to the source text via an audio output channel.

Additionally or alternatively, one or more lexical rules 220 may cover adjacent words. A lexical rule 220 in an audio model 210A and/or an electronic marquee model 210B may state that if adjacent words that rhyme or sound the same or similar when spoken, such as, “our” and “are” or “dog” and “fog”, then one of these words should be changed to a synonym.

Additionally or alternatively, a lexical rule 220 may state that for an audio output channel, a sentence with the words “no” and/or “not” may be transformed into a positive form to enhance user understandability. For example, an audio model 210A may have a lexical rule 220 which replaces the words “didn't say” with the word “denied”.

A model 210X may include syntactical rules 225. Syntactical rules 225 may be grammar based rules. Syntactical rules 225 may ensure that a transformed sentence is grammatically correct. For example, a syntactical rule may state that every sentence includes a noun and a verb. A syntactical rule 225 may ensure that every sentence has subject/verb agreement. Alternatively, a syntactical rule 225 may state that the verb-less sentence may be used. Additionally or alternatively, a syntactical rule 225 may transform sentences from passive voice to active voice.

In an embodiment, a syntactical rule 225 may transform a sentence so that the subject is as close to the predicate as feasible. Additionally or alternatively, a syntactical rule 225 may split long sentences into series of short, declarative sentences. Additionally or alternatively, a syntactical rule 225 may shorten a length of a page, paragraph or a sentence. Additionally or alternatively, a syntactical rule 225 may state that a page break may not be in a certain location based on a sized of an output channel.

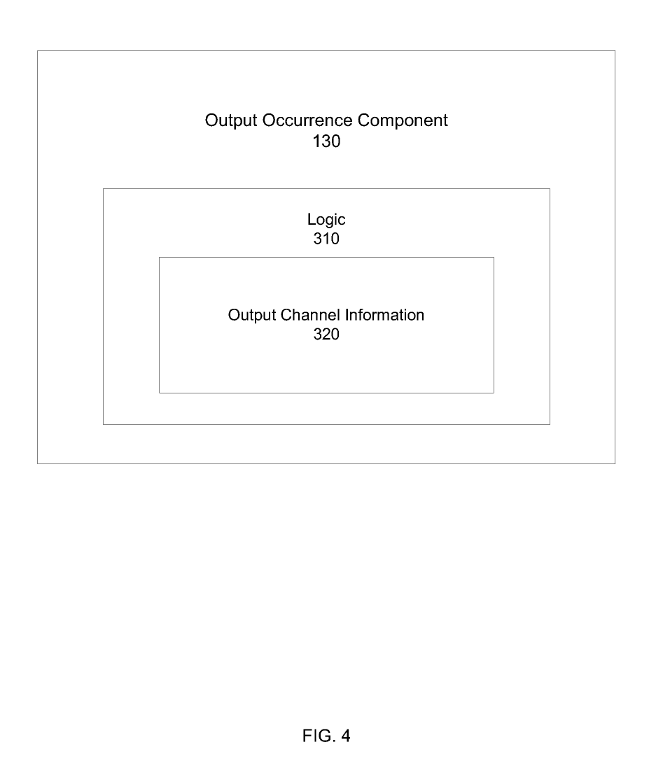

Referring back to FIG. 2, the style transformation system 100 may include an output occurrence component 130 that interacts with the style optimization component 140. FIG. 4 illustrates an embodiment of output occurrence component. The output occurrence component 130 may include logic 310 to determine the type of output channel. The logic 310 may be used to determine the type of output channel and provide information 320 based on the type of output channel.

The output occurrence component 130 may include logic to determine the type of output channel 310. In an embodiment, the output channel may be selected by the user and determined by the logic 310 in the output occurrence component 130. In an embodiment, the output channel may be dynamically determined based on the user's context. For example, the logic 310 in output occurrence component 130 may determine whether a user may want the output channel to be a speaker or a mobile display based on whether a user is driving. In an embodiment, the context of the user may be determined via output channels internal to the device, output channels external to the device, a graphical positioning system (GPS) and/or a user's schedule.

The output occurrence component 130 may use logic 310 to determine the type of output channel and provide information 320 about the intended output channel. The information 320 may include, but not limited to, attributes and/or properties of the output channel. For example, if the logic 320 determines that the output channel is a display screen, the information 320 provided may be the size of a display. For example, logic 310 may provide information about the output channel such as, but not limited to, resolution of a screen, position of a display channel output and/or a number of lines of source text that may be displayed on the output channel. Logic 310 may provide information about whether an audio channel output is mono, stereo or surround-sound.

In various embodiments, the output occurrence component 130 may provide output information 320 including context-based multi-user profiles of prospective users. In an embodiment, the profiles may be stored in a database. In an embodiment, each profile may include multiple users or prospective users of an output channel. For example, the output channel may be a projection screen and the context-based multi-user profile information may state that the prospective users are business people. The type of users may be used to determine the translation of the source text. If the context-based multi-user profile states that the prospective users on a specific channel are business people, the style optimization component 130 may include rules that translate the source text into a more formal style. Alternatively, if the source text will be displayed in an elementary school classroom, then the style optimization component 130 may include rules that translate the source text into a more informal style with simplistic vocabulary words.

In various embodiments, the output occurrence component 130 may interact with the style optimization component 140. The output occurrence component 130 may provide output information of the output channel to the style optimization component 140.

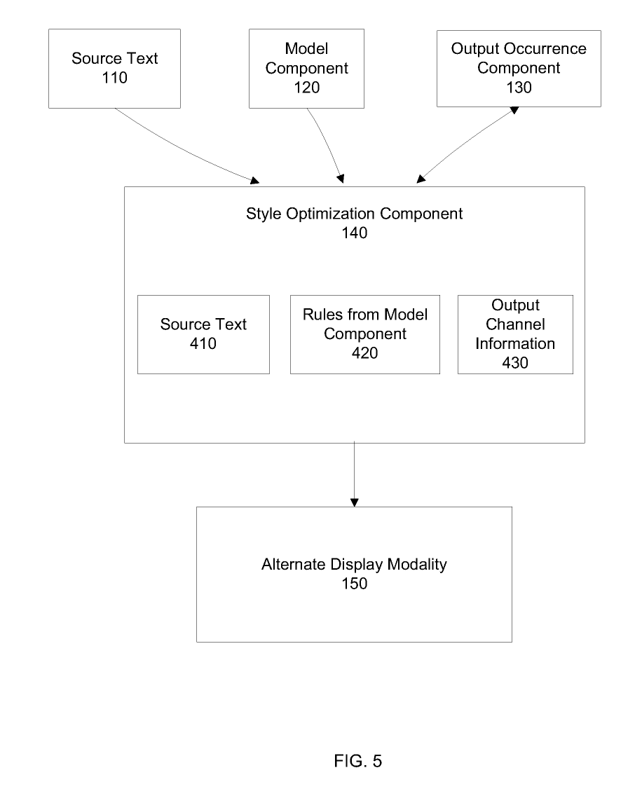

FIG. 5 illustrates one embodiment of a style optimization component 140. The style optimization component may take source text 410, rules from the model component 120, and information about the output channel from the output occurrence component 130.

The style optimization component 140 may perform style optimization and summarization of the source text 110. The style optimization component 140 may determine the output channel information 430 from the output occurrence component 130. Based on the output channel information 430, the style optimization component 140 may determine one or more rules from the model component 420 associated with the output channel. The model component rules 420 may be stylistic transformation rules which are associated with the output channel. The style optimization component 140 may apply the model component rules 420 to stylistically transform the source text 410.

In an embodiment, the style optimization component 140 may transform the source text 410 using the model component rules 420 to optimize the style for the output channel. In an embodiment, the style optimization component 140 may stylistically transformed the source text based on the information about the output channel. In an embodiment, the style of the source text may be automatically transformed based on the model component rules 420 and the output channel information 430. In an embodiment, the model component rules 420 may be applied using computer generated algorithms. In an embodiment, the style optimization component 140 may transform the source text 410 by statistical analysis. For example, the source text 410 may be stylistically transformed using probabilistic and heuristic techniques. In an embodiment, the model component rules 420 may be applied using various natural language processing techniques. The transformation techniques are not limited to these embodiments.

In an embodiment, the style optimization component 140 may transform the source text 410 by scoring and/or summarizing the source text. In an embodiment, the style optimization component 140 may be built upon a summarization system. In an embodiment, the source text may be simultaneously summarized and transformed based on the model component rules 420. In an embodiment, the style optimization component 140 may use heuristic and/or probabilistic techniques based on the summarized source text to transform the source text.

In various embodiments, the source text 410 may be scored. The source text 410 may be scored at a variety of levels, including, but not limited to, the entire document, a page, a paragraph, a sentence and/or a phrase. In an embodiment, the scoring may be based on the rules from the model component 420 and the output information from the output occurrence component 430. Alternatively, the style optimization component 140 may score based on a machine learning classification technique. In an embodiment, the score may be developed based on heuristic and/or probabilistic techniques. For example, the score of the sentence “Adam didn't say it.” may be less that the score of the sentence “Adam denied it.” based on the lexical and syntactical rules described above. As the second phrase scored higher, the second phrase may be chosen for the output channel.

In an embodiment, a score may be determined. In an embodiment, the style optimization component 140 may compare a score to a threshold value. A high score may be a score higher than a threshold value. If the style optimization component 140 determines a high score, then the source text 410 may require few or no revisions and/or restructuring for the output channel.

In an embodiment, the style optimization component 140 may determine a low score for all and/or parts of the source text 410. A low score may be a score lower than a threshold value. If a low score is determined for the entire source text 410, then an output channel may be changed. In an embodiment, the type of output channel may be automatically changed. In an embodiment, a user may be given an opportunity to change the type of output channel.

In an embodiment, low scoring source text 410 may be dropped or transformed in numerous ways. In an embodiment, model component rules 420 may be applied that correspond to the individual features for which the source text 410 has a low score. For example, the source text 410 may be scored by the sentence and a rule from the model component 420 may state that the length of a sentence must be less than a certain sentence length threshold. A sentence in the source text 410 may exceed the sentence length threshold causing the sentence to have a low score. The style optimization component 140 may apply an algorithm for splitting the sentence.

In various embodiments, a sentence may have a low score because two adjacent words may be confused as they look similar. However, each word may have a high score as they are short, informal words which score high for model component rules 420 for an electronic marquee display. Accordingly, the style optimization component 140 may determine if one or both of the words in the sentence should be transformed. In an embodiment, in order for the style optimization component 140 to determine if a word should be transformed, the style optimization component 140 may use a probabilistic model to determine if the two words are often confused. If the words are not often confused, then the style optimization component 140 may keep both words and not transform the sentence.

In various embodiments, the style optimization component 140 may distinguish global rules from local rules and apply a score based on either local rules, global rules or both. Local rules may be word or phrase specific, while global rules may be rules about the entire document. A document could have words or phrases that are less than a certain number of syllables and thus the local rules would have a high local score. In the same document, the paragraphs could be too long and a page break could occur at an inappropriate time and thus the source text 410 would receive a low global score for the global rules. The style optimization component 140 may maximize both the local and the global score. The style optimization component 140 may preference a global score over a local score. Alternatively, the style optimization component 140 may preference a local score over a global score. For example, for a source text 410 with a smaller number of words, optimizing the local rules may take precedence over optimizing the global rules.

In an embodiment, conflicting rules may occur within the style optimization component 140. In an embodiment, syntactical rules and lexical rules from the model component rules 420 may conflict for a given piece of source text 410 for a particular output channel. For example, a lexical rule may state that a word in the sentence is too long if it exceeds a word length threshold while a syntactical rule may state that a sentence is too long if it exceeds a sentence length threshold. The sentence may exceed the word length threshold bit not exceed the sentence length threshold. In an embodiment, if the style optimization component 140 preferences local rules, then optimizing the local score using the lexical rules may be a higher priority. For example, if the style optimization component 140 preferences local rules, then the style optimization component 140 may change a word of the sentence to optimize the local score even though it may result in the sentence exceeding the sentence length threshold and thus decrease the global score.

Referring back to FIG. 2, the optimized source text may be sent from the style optimization component 140 to the alternate display modality 150. The alternate display modality 150 may receive the stylized source text from the style optimization component 140. The alternate display modality 150 may send the stylized source text to an output channel. The alternate display modality 150 may ensure that the source text is received by a user via the output channel.

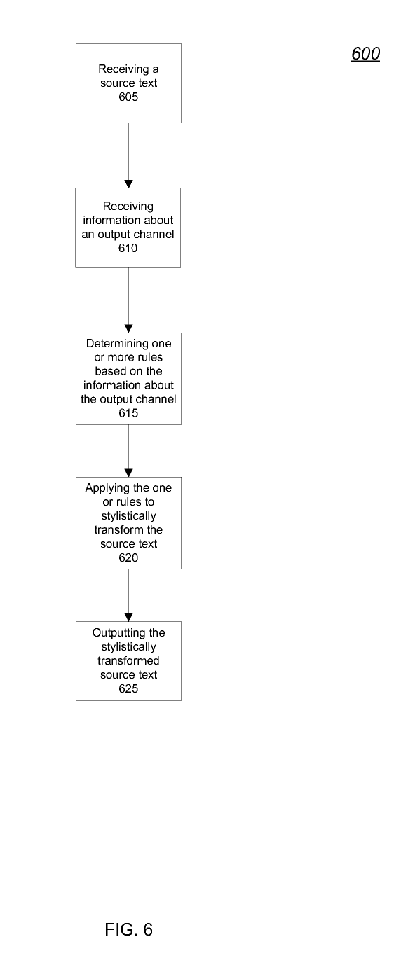

FIG. 6 illustrates an embodiment of a logic flow 600. The logic flow 600 may be performed by various systems and/or devices and may be implemented as hardware, software, firmware, and/or any combination thereof, as desired for a given set of design parameters or performance constraints. For example, one or more operations of the logic flow 600 may be implemented by executable programming or computer-readable instructions to be executed by a logic device (e.g., computer, processor). Logic flow 600 may describe the features described above with reference to apparatus 100.

In an embodiment, source text may be received 605. In an embodiment, source text may be text or other semantically based information. In an embodiment, the source text may be received 605 from any electronic text source. In an embodiment, source text may be a plurality of written document. In an embodiment, the source text may be text received from an article, a diary, a book, an email, an article, a webpage and/or a blog. In an embodiment, the source text does not have to be written text originally. The source text may have originally been speech that was converted to text via a speech recognition system. For example, source text may include voicemail or other spoken information converted into text.

In an embodiment, information may be received 610 about the output channel. In an embodiment, the output channel may be the type of channel through which the source text will be given to a user. The source text may be given to the user visually or orally. In an embodiment, the output channel may be audio via speakers. In an embodiment, the output channel may be visual on a screen, such as a LCD, plasma, an electronic marquee, a smaller display screen and/or a larger display screen. The transformed source text may be output for a formal or informal display based on context-based multi-user profiles. In an embodiment information about the output channel may include features and/or description of the channel. Information may include, but is not limited to, a size of a display. In an embodiment information may be determined by the output occurrence component. Information may include whether the channel output is a screen or audio based on the context of a user.

In an embodiment, one or more rules may be determined 615 based on the information about the output channel. In an embodiment, one or more stylistic transformation rules may be automatically determined based on the information about the output channel. In an embodiment, the one or more rules may be part of a model. In an embodiment, there may be a model for each type of output channel. In an embodiment, the one or more rules may be used to transform the style of the source text. The rules may be syntactical and/or lexical rules.

In an embodiment, the one or more rules may be applied 620 to stylistically transform the source text. In an embodiment, the rules may be applied using natural language processing. In an embodiment, the source text may be transformed using summarization and/or scoring. In an embodiment, the rules may be applied 620 using probabilistic and/or heuristic techniques. In an embodiment, the rules may overlap and/or contradict one another and the style optimization component may determine which rules to apply 620. In an embodiment, applying the transformation rules 620 may be automatic. In an embodiment, the source text may be stylistically transformed based on the information about the output channel.

In an embodiment, the transformed source text may be output 625. The transformed source text may be text or other semantically based information. In an embodiment, the transformed source text may be displayed via the output channel. In an embodiment, the transformed source text may be orally received by a user via the output channel.

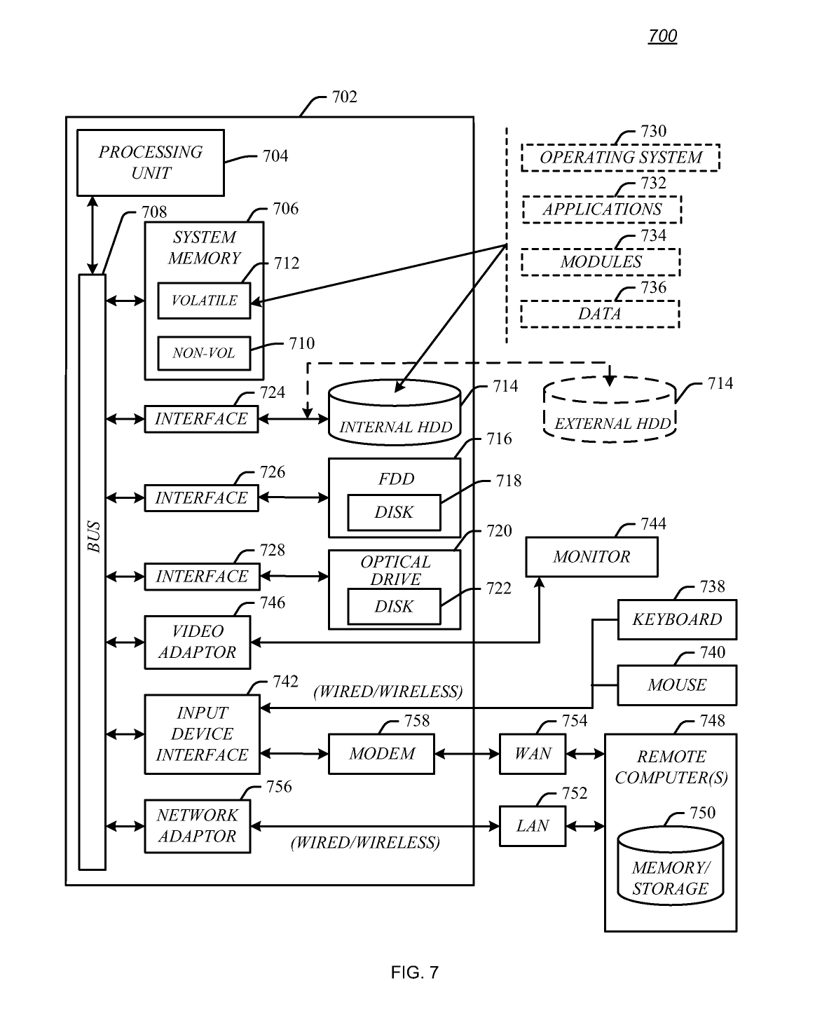

FIG. 7 illustrates an embodiment of an exemplary computing architecture 700 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 700 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the decoder.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 508 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network device, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An article comprising a non-transitory computer-readable storage medium containing instructions that when executed by a processor enable a system to:
receive a source text;
receive information about an output channel; and
stylistically transform the source text by summarizing at least a portion of the source text based on the information about the output channel.

2. The article of claim 1, comprising instructions that when executed enable the system to:
output the stylistically transformed source text.

3. The article of claim 1, comprising instructions that when executed enable the system to:
determine one or more transformation rules based on the information about the output channel.

4. The article of claim 1, comprising instructions that when executed enable the system to:
receive one or more of a type of output channel and properties of an output channel.

5. The article of claim 1, comprising instructions that when executed enable the system to:
apply natural language processing.

6. The article of claim 1, comprising instructions that when executed enable the system to:
apply one or more of probabilistic and heuristic techniques to the source text.

7. The article of claim 1, comprising instructions that when executed enable the system to:
output the transformed source text to one or more of an electronic marquee, a display screen and a speaker.

8. (canceled)

9. The article of claim 1, comprising instructions that when executed enable the system to:
score the source text.

10. The article of claim 1 comprising instructions that when executed enable the system to:
receive the source text from an electronic text source.

11. The article of claim 1, comprising instructions that when executed enable the system to:
receive context-based multi-user profiles.

12. A computer implemented method, comprising:
receiving a source text at a computing device;
receiving information about an output channel of the computing device;
stylistically transforming the source text by summarizing at least a portion of the source text based on the information about the output channel; and
outputting the stylistically transformed source text.

13. The method of claim 12 comprising:
automatically determining one or more transformation rules based on the information about the output channel.

14. The method of claim 12 comprising:
scoring the source text based on one or more stylistic transformation rules.

15. The method of claim 12 comprising:
applying natural language processing.

16. The method of claim 12, the stylistically transforming the source text comprising:
applying one or more stylistic transformation rules to the source text.

17. The method of claim 12, the stylistically transforming the source text comprising:
applying one or more of probabilistic and heuristic techniques to the source text.

18. (canceled)

19. The method of claim 12, the receiving information about an output channel comprising:
receiving context-based multi-user profiles.

20. A system comprising:
an output occurrence component operative on a processor circuit to determine information about an output channel; and
a style optimization component operative on the processor circuit to:
receive a source text,
receive the information about the output channel,
stylistically transform the source text by summarizing at least a portion of the source text based on the information about the output channel, and
output the transformed source text.

21. The system of claim 20 comprising:
a model component operative to store one or more stylistic transformation rules.

22. The system of claim 20 comprising:
a model component operative to store a different model for each output channel.

23. The system of claim 20, the style optimization component to:
obtain lexical and syntactical rules.

24. The system of claim 20, the style optimization component to:
determine one or more transformation rules based on the information about the output channel.

25. The system of claim 20, the output occurrence component to:
dynamically determine the output channel based on a user's context.

26. An apparatus, comprising:
a processor; and
a style transformation system that when executed by the processor is operative to:
receive a source text,
receive information about an output channel,
stylistically transform the source text by summarizing at least a portion of the source text based on the information about the output channel, and
output the transformed source text.

27. The apparatus of claim 26, comprising a digital display.

28. The apparatus of claim 26, comprising a speaker.

29. The apparatus of claim 26, the style transformation system to:
score the source text.

30. The apparatus of claim 26, the style transformation system operative to:
determine one or more transformation rules based on the information about the output channel.
